(19) United States
(12) Patent Application Publication
(10) Pub. No.: US 2006/0065079 A1
(43) Pub. Date: Mar. 30, 2006

(54) SWITCH FOR WRENCH WITH ADJUSTABLE HEAD

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,391

(22) Filed: Sep. 8, 2005

(30) Foreign Application Priority Data
Sep. 30, 2004 (TW) 93129736
Sep. 30, 2004 (TW) 93129737

(51) Int. Cl. B25B 13/46

(52) U.S. Cl. 81/62

(57) ABSTRACT

A wrench includes a handle, an adjustable head including a pivotal section that is pivotably connected to an end of the handle, and a switch. The adjustable head further includes a driving portion for releasably engaging with a fastener. The switch is pivotally mounted on the adjustable head between the driving portion and the pivotal section of the adjustable head. The switch comprises at least one operative end that is operable for changing a driving direction of the driving portion for driving the fastener. The operative end of the switch does not move across the pivotal section of the adjustable head when the switch is moved to change the driving direction of the driving portion.

### BACKGROUND OF THE INVENTION

1. Field of the Invention

The present invention relates to a switch for a wrench. More particularly, the present invention relates to a switch for a wrench comprising an adjustable head that can be retained in a desired angular position.

2. Description of the Related Art

FIGS. 12 and 13 of the drawings illustrate a conventional wrench comprising a handle 1, an adjustable head 2 pivotably connected to an end of the handle 1, and a switch 3 mounted on the adjustable head 2. The end of the handle 1 includes two spaced lugs 4 for pivotally receiving an end of the adjustable head 2. The adjustable head 2 can be retained in a desired angular position relative to the handle 1. The other end of the handle 1 includes a drive portion 5 that can be engaged with a fastener for loosening/tightening purposes. The switch 3 is pivotable between two positions for controlling driving direction of the driving portion 5. The switch 3 includes two opposed operative ends 6 for manual operation for switching the driving direction of the driving portion 5 along which the fastener is turned.

One of the operative ends 6 points to the driving portion 5 whereas the other operative end 6 points to the handle 1. Referring to FIGS. 14 and 15, in a case that the adjustable head 2 is at an angle with the handle 1, the operative end 6 pointing the handle 1 protrudes beyond a perimeter of the adjustable head 2 and thus causes an obstacle to the relative pivotal movement between the adjustable head 2 and the handle 1 when desired. This is because the lugs 4 on the handle 1 are hindered by the protruding operative end 6 of the switch 3.

FIGS. 16 and 17 illustrate another conventional design of the switch 3′. The switch 3′ includes an operative end 6′ that extends toward the handle 1 such that relative pivotal movement between the adjustable head 2 and the handle 1 is not allowed when the adjustable head 2 is at an angle with the handle 1, as the lugs 4 on the handle 1 are hindered by the operative end 6 of the switch 3′, as shown in FIGS. 18 and 19.

In brief, the pivotal operation of the switch 3, 3′ and the pivotal adjustment of the angle between the handle 1 and the adjustable head 2 interfere with each other in some cases.

### SUMMARY OF THE INVENTION

A wrench in accordance with the present invention comprises a handle, an adjustable head comprising a pivotal section that is pivotably connected to an end of the handle, and a switch. The adjustable head further comprises a driving portion for releasably engaging with a fastener. The switch is pivotally mounted on the adjustable head between the driving portion and the pivotal section of the adjustable head. The switch comprises at least one operative end that is operable for changing a driving direction of the driving portion for driving the fastener. The operative end of the switch does not move across the pivotal section of the adjustable head when the switch is moved to change the driving direction of the driving portion.

Preferably, the operative end of the switch extends toward the driving portion of the adjustable head.

In an embodiment of the invention, the switch comprises two operative ends between which a recession is defined for receiving a user's finger and for preventing slippage during operation of the switch. Preferably, when the switch is moved to change the driving direction of the driving portion, each operative end moves across an associated one of two lateral sides of an area between the pivotal section and the drive portion of the adjustable head.

Preferably, the adjustable head is retainable in an angular position relative to the handle.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of a wrench in accordance with the present invention.

FIG. 2 is a top view of the wrench in FIG. 1.

FIG. 3 is a side view illustrating pivotal movement of an adjustable head of the wrench in FIG. 1.

FIG. 4 is a top view of the wrench in FIG. 3, illustrating pivotal movement of a switch of the wrench.

FIG. 5 is a top view of the wrench in FIG. 1, illustrating a transition state of the switch.

FIG. 6 is a perspective view of a modified embodiment of the wrench in accordance with the present invention.

FIG. 7 is a perspective view of another modified embodiment of the wrench in accordance with the present invention.

FIG. 8 is a top view of the wrench in FIG. 7.

FIG. 9 is a side view illustrating pivotal movement of an adjustable head of the wrench in FIG. 7.

FIG. 10 is a top view of the wrench in FIG. 9.

FIG. 11 is a perspective view of a further modified embodiment of the wrench in accordance with the present invention.

FIG. 12 is a perspective view of a conventional wrench with an adjustable head.

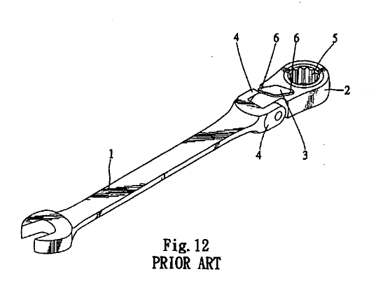

FIG. 13 is a top view illustrating pivotal movement of a switch of the conventional wrench in FIG. 12.

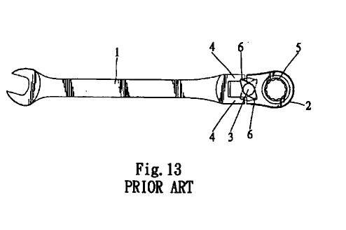

FIG. 14 is a side view of the conventional wrench in FIG. 12, wherein the wrench is at an acute angle with a handle of the wrench.

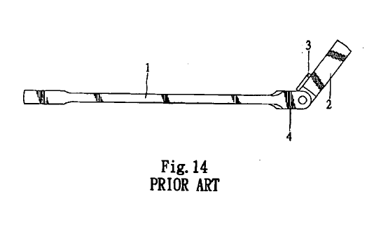

FIG. 15 is a top view of the conventional wrench in FIG. 14.

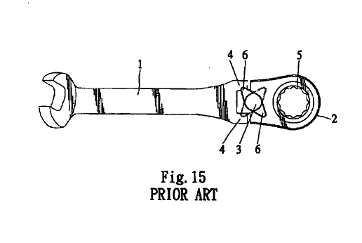

FIG. 16 is a perspective view of another conventional wrench with an adjustable head.

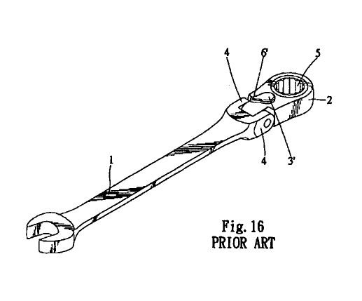

FIG. 17 is a top view of the conventional wrench in FIG. 16.

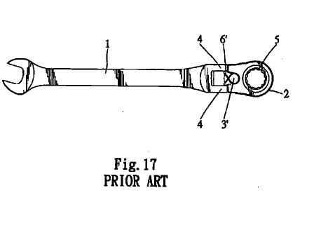

FIG. 18 is a side view of the conventional wrench in FIG. 16, wherein the wrench is at an acute angle with a handle of the wrench.

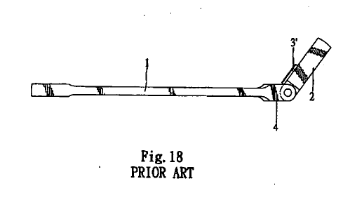

FIG. 19 is a top view of the conventional wrench in FIG. 18.

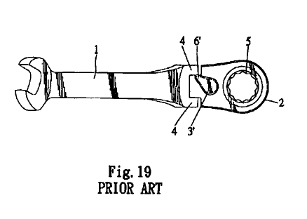

### DETAILED DESCRIPTION OF THE PREFERRED EMBODIMENTS

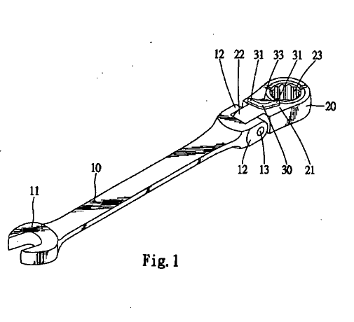

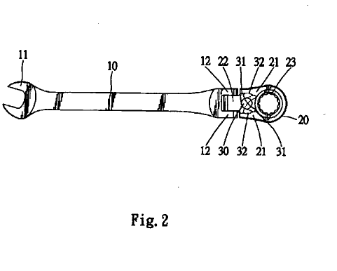

Referring to FIGS. 1 and 2, a wrench in accordance with the present invention comprises a handle 10, an adjustable head 20 pivotably connected to an end of the handle 10, and a switch 30 mounted on the adjustable head 20.

In this embodiment, the end of the handle 1 includes a pivotal portion 12 having two spaced lugs (not labeled). The other end 11 of the handle 1 is open for coupling with fasteners. It is noted that the open end 11 can be replaced with other structure as desired.

The adjustable head 2 comprises a first end, a second end, and an intermediate section 21 between the first end and the second end. The first end of the adjustable head 2 comprises a pivotal section 22 that is pivotally connected between the lugs of the pivotal portion 12 of the handle 1 by, e.g., a pin 13. Thus, the adjustable head 2 may pivot relative to the handle 10. Further, the adjustable head 2 can be retained in a desired angular position relative to the handle 1. The second end of the adjustable head 2 comprises a drive portion 23 for releasably engaging with a fastener for loosening/tightening purposes.

In this embodiment, the switch 30 is pivotable between two positions for controlling driving direction of the driving portion 23 in which a fastener is turned. For example, when the switch 30 is in a first position, a fastener engaged with the driving portion 23, when driven by the driving portion 23, is driven to turn along a first direction. When the switch 30 is in a second position, a fastener engaged with the driving portion 23, when driven by the driving portion 23, is driven to turn along a second direction reverse to the first direction. Such a mechanism is conventional and therefore not described in detail to avoid redundancy.

Of more importance, the switch 3 of the illustrated embodiment comprises two operative ends 31 for manual operation for switching the driving direction of the driving portion 23 of the adjustable head 20. As illustrated in FIGS. 1 and 2, the switch 3 is substantially streamlined, arcuate and comprises a recession 33 in an inner side thereof that faces the drive portion 23 of the adjustable head 20. The recession 33 provides a space for accommodating the finger of the user that moves the switch 30. The switch 30 would neither get stuck in the pivotal portion 12 of the handle 10 nor interfere with operation of the drive portion 23 of the adjustable head 20. This is because no part of the switch 30 moves across the pivotal portion 12 of the adjustable head 20. In an alternative arrangement, no part of the switch 30 moves across the first end of the adjustable head 20.

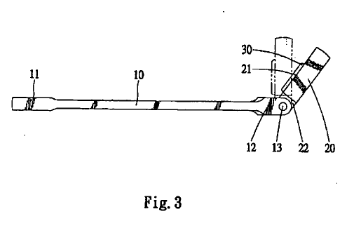

Referring to FIG. 3, the adjustable head 20 may be pivoted to and retained in any desired angular position relative to the handle 10. During the change in the relative angular position between the handle 10 and the adjustable head 20, the switch 30 on the intermediate portion 21 of the adjustable head 20 will not get stuck in the pivotal portion 12 of the handle 10. Thus, the pivotal portion 12 of the handle 10 may pivot freely relative to the pivotal section 22 of the adjustable head 20.

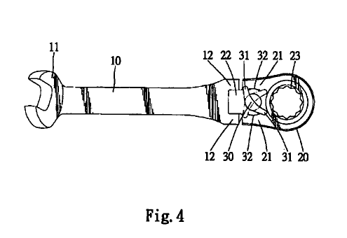

In a case that the adjustable head 20 is retained in a position at an angle other than 180 degrees with the handle 10 (i.e., not in a position shown in FIG. 1), the switch 30 in the intermediate section 21 of the adjustable head 20 still may pivot freely for the purposes of changing the driving direction of the drive portion 23. This is because the pivotal movement of each operative end 31 (see arrow 32 in FIG. 4) is on an associated one of two lateral sides of the intermediate section 21, instead of moving across the pivotal portion 12 of the adjustable head 20 that might interfere with the pivotal portion 12 of the handle 10. Thus, operation of the driving portion 23 of the adjustable head 20 is not adversely affected.

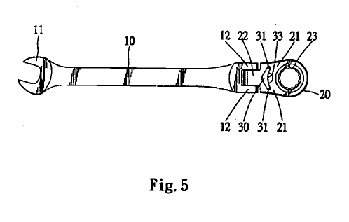

Referring to FIG. 5, when the switch 30 is manually pivoted by the user, the associated operative end 31 of the switch 30 is moved toward (or away from) the driving portion 23 of the adjustable head 20. Nevertheless, due to provision of the recession 33 of the switch 30, slippage would not occur while moving the switch 30.

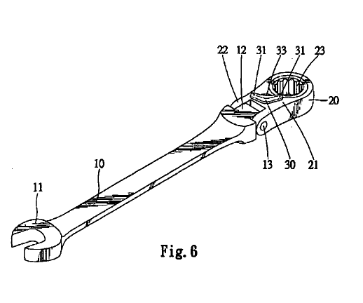

FIG. 6 illustrates a modified embodiment of the invention, wherein the pivotal connection between the adjustable head 20 and the handle 10 is modified. More specifically, the pivotal portion 12 of the handle 10 is pivotally connected between two spaced lugs (not labeled) of the pivotal section 22 of the first end of the adjustable head 20. This embodiment also comprises a switch 30 that provides advantages the same of the above embodiment, for no part of the switch 30 moves across the pivotal section 22 of the adjustable head 20.

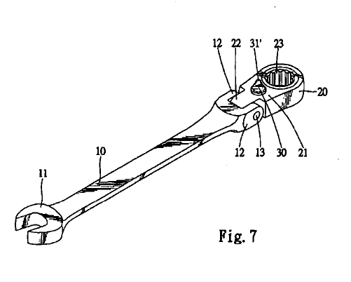

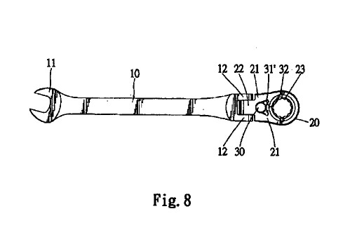

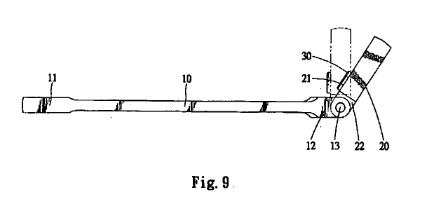

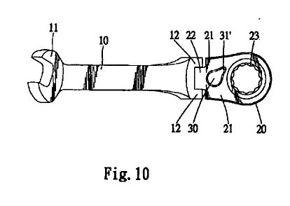

FIG. 7 is a perspective view of another modified embodiment of the wrench in accordance with the present invention. FIG. 8 is a top view of the wrench in FIG. 7. FIG. 9 is a side view illustrating pivotal movement of an adjustable head of the wrench in FIG. 7. FIG. 10 is a top view of the wrench in FIG. 9.

In this embodiment, the switch member 30 comprises an operative end 31′ that extends toward the drive portion 23 of the adjustable head 20. The operative end 31′ of the switch 30 will not move across the pivotal section 22 (or even the first end) of the adjustable head 20 during manual operation of the switch 30 for changing the driving direction of the driving portion 20. Thus, the operative end 31′ of the switch 30 will not get stuck in the pivotal portion 12 of the handle 10 and operation of the driving portion 23 of the adjustable head 20 is not adversely affected.

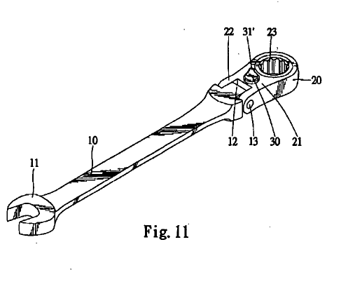

FIG. 11 illustrates a modified embodiment modified from the embodiment of FIGS. 7 through 10, wherein the pivotal connection between the adjustable head 20 and the handle 10 is modified. More specifically, the pivotal portion 12 of the handle 10 is pivotally connected between two spaced lugs (not labeled) of the pivotal section 22 of the first end of the adjustable head 20. This embodiment also comprises a switch 30 with an operative end 31′ that provides advantages the same of the above embodiments, for no part of the switch 30 moves across the first end of the adjustable head 20.

As apparent from the foregoing, the pivotal operation of the switch 3, 3′ will not be adversely affected by the relative angular position between the handle 1 and the adjustable head 2, and the pivotal adjustment of the angle between the handle 1 and the adjustable head 2 will not be hindered by the switch 3, 3′. Thus, changing of the driving direction of the driving portion 23 of the wrench and the adjustment of the relative angular position between the handle 1 and the adjustable head 2 can be proceeded independently without interfering with each other.

Although specific embodiments have been illustrated and described, numerous modifications and variations are still possible without departing from the essence of the invention. The scope of the invention is limited by the accompanying claims.

What is claimed is:

1. A wrench comprising:
a handle having an end;
an adjustable head comprising a pivotal section that is pivotably connected to the end of the handle, the adjustable head further comprising a driving portion adapted to releasably engage with a fastener; and
a switch pivotally mounted on the adjustable head between the driving portion and the pivotal section of the adjustable head, the switch comprising at least one operative end that is operable for changing a driving direction of the driving portion for driving the fastener;
wherein said at least one operative end of the switch does not move across the pivotal section of the adjustable head when the switch is moved to change the driving direction of the driving portion.

2. The wrench as claimed in claim 1 wherein said at least one operative end of the switch extends toward the driving portion of the adjustable head.

3. The wrench as claimed in claim 1 wherein a number of said at least one operative end of the switch is two.

4. The wrench as claimed in claim 1 wherein the switch further comprises a recession.

5. The wrench as claimed in claim 3 wherein the switch further comprises a recession between the two operative ends.

6. The wrench as claimed in claim 1 wherein the adjustable head is retainable in an angular position relative to the handle.

7. The wrench as claimed in claim 3 wherein when the switch is moved to change the driving direction of the driving portion, each said operative end moves across an associated one of two lateral sides of an area between the pivotal section and the drive portion of the adjustable head.
